(19) United States
(12) Patent Application Publication
(10) Pub. No.: US 2023/0265894 A1
(43) Pub. Date: Aug. 24, 2023

(54) ELASTIC BODY

(71) Applicant: Süddeutsche Gelenkscheibenfabrik GmbH & Co. KG, Waldkraiburg (DE)

(72) Inventors: Steffen Jerye, Haag (DE); Marian Kynast, Haiming (DE); Bernd Scheper, Reichertsheim (DE)

(73) Assignee: Süddeutsche Gelenkscheibenfabrik GmbH & Co. KG, Waldkraiburg (DE)

(21) Appl. No.: 18/113,292

(22) Filed: Feb. 23, 2023

(30) Foreign Application Priority Data
Feb. 23, 2022 (DE) 10 2022 104 347.9

(51) Int. Cl. F16D 3/62; F16D 3/70; B62D 1/16

(52) U.S. Cl. CPC F16D 3/62; F16D 3/70; B62D 1/16

(57) ABSTRACT

An elastic body is provided having at least two fastening apertures, at least one thread package surrounding the at least two fastening apertures, at least one elastic sheath at least partially sheathing the at least one thread package, and wherein the elastic body has at least one positioning point at at least one fastening aperture on the elastic sheath, via which the position of the at least one thread package in the elastic sheath is adjustable at least in the axial direction.

### FIELD OF THE INVENTION

The present invention relates to an elastic body comprising at least one thread package and at least two fastening apertures around which the at least one thread package passes.

### BACKGROUND OF THE INVENTION

Elastic bodies are known from the prior art and disclosed, for example, in document DE 27 05 598 A1. The body disclosed in this document comprises bushings arranged at regular angular distances around an axis, two of which each are wrapped by thread packages. Together, the bushings and the thread packages are embedded in an elastomeric material. The areas between the individual outer bushings are also filled with the elastomeric material in which the thread packages are embedded.

The elastic sheath of the thread packages and their positioning in the elastic sheath are of great importance for the function and service life of the elastic body. Both a defective elastomeric sheath and a thread package that is positioned outside certain tolerances can reduce the service life as well as impair the function of the joint body, e. g. the transmission of forces and torques while compensating for angular misalignment.

### SUMMARY OF THE INVENTION

It is an object of the present invention to provide an elastic body that can reliably ensure the function of the elastic body with increased service life.
This object is achieved with an elastic body having the features of an elastic body comprising at least two fastening apertures; at least one thread package surrounding the at least two fastening apertures; at least one elastic sheath at least partially sheathing the at least one thread package; and wherein the elastic body has at least one positioning point at at least one fastening aperture on the elastic sheath, via which the position of the at least one thread package in the elastic sheath is adjustable at least in the axial direction.
Further embodiments include the elastic body wherein a plurality of positioning points are provided in the elastic sheath in the wrap-around area in which the at least one thread package surrounds one of the fastening apertures. In another embodiment, the at least one positioning point extends in the radial direction. In another embodiment, the positioning points, with respect to the central axis of a fastening aperture, are configured at the fastening aperture with an offset relative to each other by a predetermined angular distance. In another embodiment, at least one positioning point is provided between two fastening apertures. In another embodiment, the elastic body has two axial sides, wherein positioning points are configured in the elastic sheath on each axial side. In another embodiment, the positioning points have different axial depths. In another embodiment, the at least one thread package is arranged in the axial direction between two positioning points. In another embodiment, the at least one positioning point extends in the direction of one of the axial side surfaces of the at least one thread package. In another embodiment, a layer of the elastic sheath remains in place between the bottom of the at least one positioning point and the at least one thread package. In another embodiment, the thickness of the elastic sheath changes circumferentially on an axial side of the elastic body. In another embodiment, the thickness of the elastic sheath is the greatest in the area of the fastening apertures. In another embodiment, the elastic sheath has at least one recess on at least one axial side of the elastic body. In another embodiment, the elastic body comprises at least one sprue element, wherein at least the at least one thread package, starting from the at least one sprue element, is at least partially sheathed with an elastic sheath. In another embodiment, the at least one sprue element is configured on at least one surface of the elastic body extending in the axial direction. In another embodiment, the at least one sprue element is at least one sprue bar. In another embodiment, the elastic body comprises at least one central aperture, wherein the central aperture has an inner peripheral surface on which the at least one sprue element is configured. In another embodiment, the at least one sprue element is configured on the elastic sheath radially inwardly or radially outwardly of the at least one fastening aperture with respect to the central axis of the elastic body. In another embodiment, the elastic body is formed by arranging at least one thread package in an injection mold, wherein the at least one thread package is held in a predetermined position by a retainer at at least one positioning point, wherein the retainer holds the at least one thread package in the predetermined axial position throughout the injection process and vulcanization process of the elastic body. In yet another embodiment, the at least one elastic body is configured for connection to at least one two-armed flange. In still another embodiment, the at least one elastic body is configured for use in a vehicle's steering column.

The elastic body comprises at least two fastening apertures, at least one thread package surrounding the at least two fastening apertures, and at least one elastic sheath at least partially sheathing the at least one thread package. The elastic body has at least one positioning point at at least one fastening aperture on the elastic sheath, via which the position of the at least one thread package in the elastic sheath is adjustable at least in the axial direction.

The at least one positioning point helps to ensure that the at least one thread package is in its predetermined axial position in the elastic sheath. The at least one positioning point can further be used to adjust the course of the thread package in the elastic sheath. In other words, the at least one elastic sheath can be used to adjust the position and the course of the at least one thread package with respect to the elastic sheath. As a result, the elastic body can absorb higher forces and torques throughout its service life, and the overall service life of the elastic body can be improved.

Because of the exact positioning and the defined course of the at least one thread package in the elastic sheath, the layer thickness of the layer of the elastic sheath covering the at least one thread package can be adapted to the requirements on the elastic body and the mechanical properties of the elastic body at least in places or in sections. The exact axial positioning and the defined course of the at least one thread package in the elastic sheath allow, for example, a smaller layer thickness at least of the layer of the elastic sheath covering the axial side surfaces of the thread package. This helps to save material when manufacturing the elastic sheath.

The at least one positioning point can further ensure that the elastic body has the specified mechanical properties. By exactly positioning the at least one thread package in the elastic sheath, the stiffness of the elastic body can be adjusted more precisely. This applies in particular to the elastic body's axial stiffness and torsional stiffness.

In the area of the elastic body in which the at least one thread package surrounds one of the fastening apertures, several positioning points can be provided on the elastic sheath. This area can also be referred to as the “wrap-around area” since the at least one thread package wraps and/or passes around the fastening apertures in a curved manner.

The fastening apertures may be used to receive fasteners. Such fasteners can be used to couple the elastic body to elements or assemblies to be connected. Such fasteners can further be used to couple the elastic body to other elastic bodies. The fasteners may be have the shape of a bushing or rivet. The fasteners may have a bolt-shaped or tubular portion and a disk-shaped portion. The disk-shaped portion may form an axial end portion of the fasteners.

The at least one positioning point may extend in the radial direction. If a plurality of positioning points are provided, all positioning points may extend in the radial direction with respect to the central axis of the elastic body and/or with respect to the central axis of a mounting surface.

The at least one positioning point may be elongated or round. The at least one positioning point may have at least one rounded end. The at least one positioning point may have two rounded ends. The at least one positioning point may be notch-shaped. The positioning point may have at least one open end in the radial direction. The at least one positioning point may be slit-shaped.

The at least one positioning point may be assigned to a fastening aperture. If a plurality of positioning points are provided, one group of these positioning points may be assigned to a fastening aperture, and another group of these positioning points may be assigned to at least one further fastening aperture. The positioning points may be configured at the fastening aperture with an offset relative to each other by a predetermined angular distance with respect to the central axis of a fastening aperture. Starting from the fastening aperture, the positioning points may extend in the radial direction. At least two of the positioning points may have a spacing with a predetermined angular amount between them, depending on the angular amount at which the at least one thread package rotates around the at least one fastening aperture. The positioning points arranged in the area of a fastening aperture may be used to position the at least one thread package in the area of a mounting surface.

At least one positioning point may be provided between two fastening apertures. Accordingly, in addition or as an alternative to the positioning point at one of the fastening apertures, at least one positioning point may be configured in the circumferential direction between two fastening apertures in the elastic sheath. This can ensure the exact positioning of the thread package in the area between two fasteners, i.e. in a central area of the thread package.

The elastic body may have two axial sides. At least one positioning point may be configured on each axial side. The at least one thread package may be arranged in the axial direction between two positioning points. The at least one thread package can thus be held in position, starting from the two axial sides of the elastic body.

The positioning points may have different axial depths, i.e. the positioning points may differ in axial depth. For example, the axial depth of the positioning points that are configured on different axial sides of the elastic body may differ. The depth of the positioning points may depend on their position on the elastic body. For example, the axial depths of the positioning points that are circumferentially offset relative to each other by predetermined angular amounts may differ. Furthermore, the axial depths of the positioning points may differ if they are assigned to the same fastener but arranged on different axial sides of the elastic body.

A layer of the elastic sheath may remain in place between the bottom of the at least one positioning point and the at least one thread package.

The thickness of the elastic sheath may change circumferentially on an axial side of the elastic body. The thickness of the elastic sheath may be the greatest in the area of the fastening apertures.

The elastic sheath may have at least one recess on at least one axial side of the elastic body. The at least one recess may extend into the elastic sheath in the axial direction. The recesses on one axial side may be configured on the elastic sheath with an offset relative to each other by a predetermined angular amount. At least one recess may be configured on each axial side of the elastic body. The recesses on different axial sides of the elastic body may be offset relative to each other by a predetermined angular amount. In the circumferential direction, the recesses may thus extend alternately into the elastic sheath in the axial direction. The recesses may reduce the thickness of the elastic sheath in predetermined areas of the elastic body. The at least one recess allows the stiffness of the elastic body to be adjusted. This applies in particular to the axial stiffness of the elastic joint body.

The elastic body may have at least one sprue element. The at least one sprue element may be configured on a surface of the elastic body extending in the axial direction. Starting from the at least one sprue element, at least the at least one thread package may be at least partially sheathed with the elastic sheath. The at least one sprue element on at least one surface extending in the axial direction of the elastic body can ensure that the rubber elastic sheath is formed more uniformly and reliably. With the at least one sprue element, the influence of the at least one thread package can be taken into account when forming the elastic sheath. In addition, this can reduce the occurrence of air pockets in the elastic sheath. The uniformly and completely formed elastic sheath of the elastic body improves the elastic body's service life and ensures that the elastic body performs its function satisfactorily on a permanent basis.

The at least one sprue element may be a sprue point. The at least one sprue point may be configured on a surface of the elastic body extending in the axial direction.

The at least one sprue element may be at least one sprue bar. The at least one sprue bar may be configured on a surface of the elastic body extending in the axial direction. The at least one sprue bar may extend in a vertical direction or a horizontal direction on the surface extending in the axial direction. The at least one sprue bar extending in the horizontal direction may be configured as a closed ring. The sprue bar extending in the horizontal direction may further have interruptions, i.e. be divided into individual sections or subsegments.

A plurality of sprue bars may be provided. The sprue bars may be offset relative to each other at predetermined angular distances on a surface of the elastic body extending in the axial direction.

The at least one sprue element may be configured on a surface of the elastic body extending in the axial direction in the area of at least one fastening aperture. Because of its diameter, the at least one fastening aperture may occupy a predetermined angular range. The at least one sprue element may be configured on the surface extending in the axial direction within the angular range occupied by the at least one fastening aperture.

The elastic body may have at least one central aperture. The at least one central aperture may have an inner peripheral surface on which the at least one sprue element is configured. A plurality of sprue elements may be configured on the inner peripheral surface. The sprue elements may be offset relative to each other by predetermined angular distances on the inner peripheral surface.

The at least one sprue element may be configured on the elastic sheet radially inwardly or radially outwardly of the at least one fastening aperture with respect to the central axis of the elastic body. The at least one sprue element may be configured in the radial direction between the central axis of the elastic body and one of the fastening apertures. The at least one sprue element may be on an imaginary straight line between the central axis of the elastic body and the central axis of one of the fastening apertures.

The elastic body may be formed by arranging at least one thread package in an injection mold. The at least one thread package may be held in a predetermined position by retainer at at least one positioning point. The at least one thread package may be held in the predetermined axial position by the retainer throughout the injection process and vulcanization process. The retainer can hold the at least one thread package in its predetermined axial position from both axial sides of the elastic body to be manufactured.

The at least one thread package may be held in the predetermined axial position by the same retainer throughout the injection and vulcanization process.

The elastomeric compound forming the elastic sheath may be introduced into the injection mold in such a way that at least one sprue element is formed on a surface of the elastic body extending in the axial direction, wherein the at least one thread package, starting from the at least one sprue element, can be at least partially sheathed by the elastomeric compound forming the elastic sheath, forming the at least one positioning point.

A plurality of sprue elements may be configured on the inner peripheral surface of the central aperture of the elastic body. All sprue elements may extend in the axial direction of the elastic body. The sprue elements extending in the axial direction of the elastic body may be arranged around the central axis of the elastic body with an offset relative to each other by regular angular distances. Starting from the plurality of sprue elements, the at least one thread package can be sheathed with the rubber elastic sheath. The offset sprue elements can help to achieve a uniform elastic sheath with fewer air pockets.

The elastic body may be configured for connection to at least one 2-armed flange. The elastic body may be connected to two 2-armed flanges.

The elastic body may in particular be configured for use in a vehicle's steering column. The elastic body may be a joint disk, including, without limitation, for vehicle steering systems.

The elastic body may be an elastic joint body for a shaft assembly for articulating two shaft portions. The elastic joint body may have the following features:

a plurality of fasteners circumferentially spaced at predetermined angular distances with respect to a central axis of the joint body, and a plurality of thread packages each wrapping around two adjacent fasteners, the fasteners and the thread packages being at least partially sheathed by the elastic sheath. The fasteners may have the shape of a bushing or rivet.

### BRIEF DESCRIPTION OF THE SEVERAL VIEWS OF THE DRAWING

In the following, example embodiments are described with reference to the accompanying figures. In the drawings:

FIGS. 1 and 2 are perspective views of an elastic body according to a first embodiment;

FIGS. 3 and 4 are perspective views of the elastic joint body according to the first embodiment including fasteners;

FIG. 5 is a front view of the elastic body according to the first embodiment;

FIG. 6 is a top view of the elastic body according to the first embodiment;

FIG. 7 is an enlarged view of section VII in FIG. 6;

FIG. 8 is a sectional view along section line VIII-VIII in FIG. 6;

FIG. 9 is an enlarged view of section IX in FIG. 8;

FIG. 10 is a sectional view along section line X-X in FIG. 6;

FIG. 11 is a perspective view of an elastic body according to a second embodiment;

FIG. 12 is a front view of the elastic body according to the second embodiment;

FIG. 13 is a top view of the elastic body according to the second embodiment;

FIG. 14 is an enlarged view of section XIV in FIG. 13;

FIG. 15 is a sectional view along section line XV-XV in FIG. 13;

FIG. 16 is an enlarged view of section XVI in FIG. 15; and

FIG. 17 is a sectional view along section line XVII-XVII in FIG. 13.

### DETAILED DESCRIPTION OF THE INVENTION

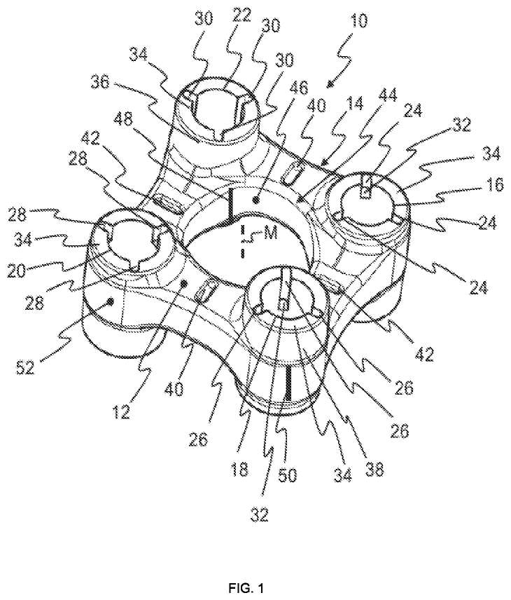

FIGS. 1 and 2 are perspective views of an elastic body according to a first embodiment. The elastic body is generally designated as 10. The elastic body 10 according to the first embodiment is a joint body which may also be referred to as a joint disk. FIG. 1 illustrates in particular the axial side 12 of the elastic body 10.

The elastic body 10 has an elastic sheath 14. The elastic body 10 has four fastening apertures 16, 18, 20 and 22. Positioning points 24, 26, 28 and 30 are configured at each of the fastening apertures 16, 18, 20, 22. According to this embodiment, three positioning points 24, 26, 28, 30 are configured at each fastening aperture 16, 18, 20, 22. However, more or fewer positioning points may be provided at the fastening apertures 16, 18, 20, 22. The three positioning points 24, 26, 28, 30 assigned to the respective fastening aperture 16, 18, 20, 22 are arranged around the respective fastening aperture 16, 18, 20 and 22 with an offset relative to each other by a predetermined angular distance.

The positioning points 24, 26, 28 and 30 extend into the elastic sheath 14 in the axial direction. The positioning points 24, 26, 28 and 30 can be used to position thread packages, which are not shown in FIG. 1. The positioning points 24, 26, 28, and 30 each have a bottom 32 that is fully visible at one of the positioning points 24 and at one of the positioning points 26. The elastic body 10 has an annular surface 34 at each of the fastening apertures 16, 18, 20 and 22. Each of the fastening apertures 16, 18, 20 and 22 is surrounded by an annular surface 34. Starting from this annular surface 34, the positioning points 24, 26, 28 and 30 extend into the elastic sheath 14 of the elastic body 10 in the axial direction.

On the axial side 12 of the elastic body 10, the elastic sheath 14 has projections 36 and 38 at the fastening apertures 18 and 22. The annular surface 34 is configured on the projections 36 and 38. Because of the projections 36 and 38, the axial depth of the positioning points 26 and differs from the axial depth of the positioning points 24 and 28. The positioning points 26 and 30 extend deeper into the elastic sheath 14 than the positioning points 24 and 28. This can be clearly seen at the positioning points 24 and 26 whose bottom 32 is shown in FIG. 1.

Further positioning points 40 and 42 are configured between the fastening apertures 16, 18, 20, 22. The positioning points 40 and 42 are configured in the circumferential direction between two adjacent fastening apertures 16, 18, 20 and 22. The two positioning points with the reference sign 40 are identical. The positioning points 40 have the same axial depth. The two positioning points with the reference sign 42, too, are identical and have the same axial depth. The positioning points 40 and 42 differ in axial depth. The positioning points 42 extend deeper into the elastic sheath 14 than the positioning points 40. The positioning points 40 and 42 are configured alternately on the elastic body 10 in the circumferential direction. The depth of the positioning points 40 and 42 depends on where the thread package, which is not shown, is to be positioned in the area of the elastic sheath 14 having the positioning points 40 and 42.

The elastic body 10 has a central aperture 44. The central aperture 44 extends through the elastic body 10 centrally and in the axial direction. The aperture 44 has an inner peripheral surface 46. A sprue bar 48 is provided on the inner peripheral surface 46 of the central aperture 44. The sprue bar 48 extends along the inner peripheral surface 46 in the axial direction. The axial sprue bar 48 is configured on the inner peripheral surface 46 radially inwardly of the fastening aperture 22. The sprue bar 48 is configured on the inner peripheral surface 46 between the central axis M and the fastening aperture 22 in the radial direction.

Additionally or alternatively, a sprue bar 50 may be configured on the outer surface 52 of the elastic body 10. The sprue bar 50 is configured on the outside of the elastic body 10 and/or the elastic sheath 14 in the area of the fastener 18. The sprue bar 50 extends along the outer surface 52 in the axial direction.

Starting from the sprue bars 48 and/or 50, the thread packages, which are not shown in FIG. 1, are sheathed with the elastic sheath 14. For the design and manufacture of the elastic body it is sufficient when the axial sprue bars 48, 50 are configured either on the inner peripheral surface 46 of the central aperture 44 or the outer surface 52 of the elastic body 10. As can be seen in FIG. 1, the sprue bars 48, 50 extend substantially parallel to the central axis M of the elastic body 10.

According to this embodiment, the axial sprue bars 48, 50 extend over the full axial extent of the inner peripheral surface 46 and the outer surface 52. However, the sprue bars 48, 50 do not necessarily have to be designed in this way and may extend only over portions of the axial extent of the corresponding surfaces 48 or 50.

FIG. 2 is a further perspective view of the elastic body 10, showing in particular the axial side 54 of the elastic body 10. FIG. 2 thus shows the “underside” of the elastic body 10 as shown in FIG. 1.

FIG. 2 shows the fastening apertures 16, 18, 20, 22 in the elastic sheath 14. On the axial side 54 of the elastic body 10, projections 36, 38 are configured at the fastening apertures 16 and 20. Positioning points 56, 58, 60 and 62 are again configured at the fastening apertures 16, 18, 20 and 22. The above explanations about the positioning points 24, 26, 28, 30 apply analogously to the positioning points 56, 58, 60 and 62.

The positioning points 56 on the axial side 54 of the elastic body 10, which are assigned to the fastening aperture 16, interact with the positioning points 24 on the axial side 12. This also applies to the positioning points 58, 60, 62 on the axial side 54, which interact with the positioning points 26, 28 and 30 on the axial side 12 of the elastic body 10. The positioning points 56, 58, 60 and 62 on the axial side 54 interact with the positioning points 24, 26, 28 and on the axial side 12 for positioning the thread packages, which are not shown in FIGS. 1 and 2.

The positioning points 40 and 42 are configured on the axial side 54 in the circumferential direction between the fastening apertures 16, 18, 20 and 22. The positioning points 40 and 42 are alternately configured on the elastic body 54 in the circumferential direction.

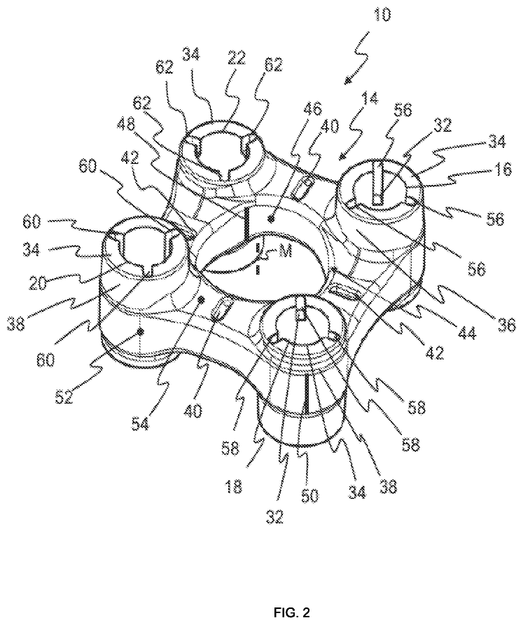

FIGS. 3 and 4 are perspective views of the elastic body 10, with FIG. 3 showing the axial side 12 and FIG. 4 showing the axial side 54 of the elastic joint body 10. FIG. 3 corresponds to the view shown in FIG. 1, and FIG. 4 corresponds to the view shown in FIG. 2, however, fasteners 64, 66, 68, 70 are included in each case.

The elastic body 10 includes the fasteners 64, 66, 68, 70. The fasteners 64, 66, 68 and 70 are received in the fastening apertures 16, 18, 20 and 22. The fasteners 64, 66, 68, and 70 are wrapped by the thread packages, which are not shown. The fasteners 64, 66, 68 and 70 are arranged at predetermined angular distances from one another in the circumferential direction with respect to a central axis M.

Each of the fasteners 64, 66, 68, and 70 has a bolt-shaped portion 72 and a disk-shaped end member 74. The fasteners 64, 66, 68, and 70 extend alternately from the axial side 12 and the axial side 54 through the elastic sheath 14. Accordingly, the disk-shaped end members 74 of the fasteners 64 and 68 rest against the axial side 12, and the disk-shaped end members 74 of the fasteners 66 and 70 rest against the axial side 54.

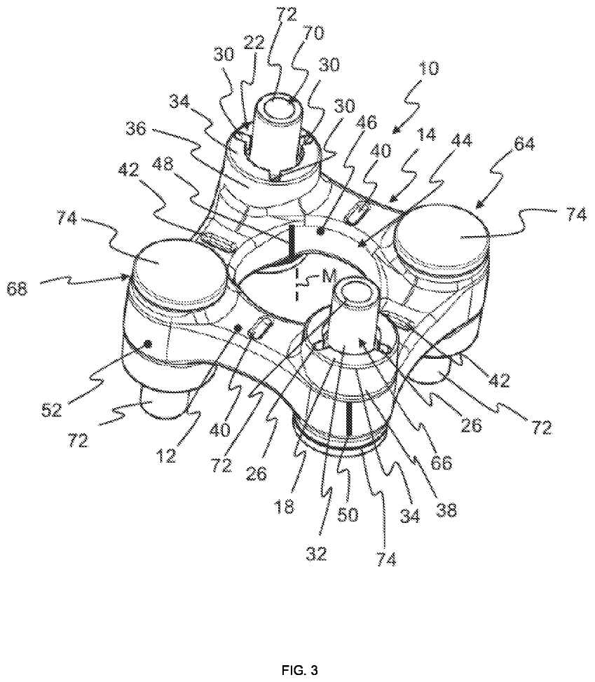

FIG. 5 is a front view of the elastic body 10. According to this embodiment, the fasteners 64, 66, 68 and 70 extend through the elastic sheath 14. The sprue bar 50 is visible on the outer surface 52 of the elastic body 10 and/or the elastic sheath 14. The sprue bar 50 extends on the outer surface 52 in the axial direction. The sprue bar 50 extends over the full axial extent of the outer surface 52. The sprue bar 50 is provided radially on the outside of the elastic sheath 14 in the area of the fastener 66.

Axial recesses 76 and 78 of the elastic sheath 14 are configured on the axial sides 12 and 54. The axial recesses 76 and 78 are configured on the axial sides 12 and 54 of the elastic body 10 with an offset relative to each other in the circumferential direction of the elastic body 10. In the areas including the recesses 76 and 78, the elastic sheath 14 has a reduced axial extent and a reduced axial thickness, respectively. Such reduced axial thickness is achieved, among other things, with the positioning points 24, 26, 28, 30 and 56, 58, 60, 62 (see FIGS. 1 to 4) in the elastic sheath 14 of the elastic body 10, which adjust the axial position and the defined course of the corresponding thread package in the elastic sheath 14.

The fasteners 64 and 68 extend through the elastic sheath 14 such that their disk-shaped end members 74 are disposed on the axial side 12 of the elastic body 10. The tubular portions 72 of the fasteners 64 and 68 protrude from the elastic sheath 14 on the axial side 54. The disk-shaped end members 74 of the fasteners 66 and 70 are disposed on the axial side 54. The tubular portions 72 of the fasteners 66 and 70 jut out the elastic sheath 14 on the axial side 12.

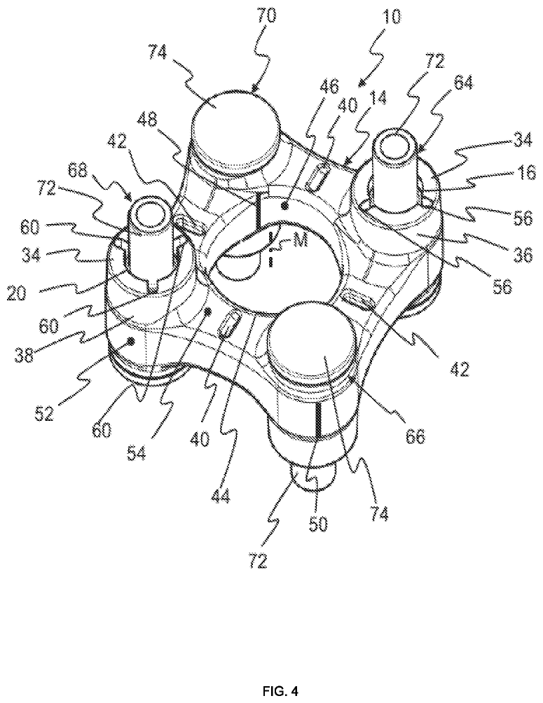

FIG. 6 is a top view of the elastic body 10. The elastic body 10 comprises the elastic sheath 14 in which the fasteners 64, 66, 68, 70 are at least partially arranged. The fasteners 64, 66, 68, 70 are arranged about the central axis M of the elastic body 10 with an offset relative to each other by predetermined angular distances. The elastic body 10 further includes the central aperture 44 having the inner peripheral surface 46. The central aperture 44 may be substantially circular. However, the central aperture 44 may have a different shape.

In the top view according to FIG. 6, positioning points 40, 42 can be seen. The positioning points 40 and 42 are configured in the circumferential direction between the fastening apertures 16, 18, 20, 22 and between the fasteners 64, 66, 68, 70, respectively. The positioning points 40 and 42 may be arranged with an offset relative to each other by predetermined angular distances with respect to the central axis M of the elastic body 10. Each of the positioning points 40 and 42 is arranged with an offset relative to the two adjacent fasteners 64, 66, 68, 70 by a predetermined angular distance with respect to the central axis M of the elastic body 10. The positioning points 40 and 42 have an elongated shape with rounded ends. The positioning points 40 and 42 extend in the elastic sheath 14 in the radial direction, i.e. the positioning points 40 and 42 are on an imaginary radial line starting at the central axis M of the elastic body 10.

FIG. 6 shows the disk-shaped end member 74 of the fasteners 66 and 70, and the tubular portion 72 of the fasteners 64 and 68. The fasteners 66, 70 and the fasteners 64 and 68 thus extend through the elastic sheath 14 in opposite directions. In particular, the fasteners 64, 66, 68, 70 extend through the elastic sheath 14 alternately in opposite directions in the circumferential direction.

The positioning points 56 and 60 are arranged around the fasteners 64, 68. The positioning points 56 are arranged around the fastener 64, and the positioning points 60 are arranged around the fastener 64. The positioning points 56, 60 are arranged around the central axes MB₁₆ and MB₂₀ of the fastening apertures 16 and 20 and the fasteners 64, 68, respectively, at predetermined angular distances with an offset relative to each other.

The sprue bars 48 are configured on the inner peripheral surface 46 of the central aperture 44. The sprue bars 48 extend on the inner peripheral surface 46 in the axial direction. The sprue bars 48 are disposed radially inwardly of the fasteners 64, 66, 68, 70. A sprue bar 48 may be assigned to each fastener 64, 66, 68, 70. The sprue bars 48 are arranged in the radial direction between the central axis M of the elastic body 10 and the central axes of the fasteners 64, 66, 68, 70 for which FIG. 6 shows the central axes MB₁₆ and MB₂₀ of the fastening apertures 16 and 20 and of the fasteners 64 and 68, respectively. The central axes MB₁₆ and MB₂₀ of the fastening apertures 16, 18, 20, 22 coincide with the central axes of the fasteners 64, 66, 68, 70. As exemplified by the central axes MB₁₆ and MB₂₀ of the fasteners 64, 68, the sprue bars 48 are arranged on imaginary radial lines extending between the central axis M of the elastic body and the central axis MB₁₆ of the fastener 64 and the central axis MB₂₀ of the fastener 68.

The sprue bars 48 may be disposed on the inner peripheral surface 46 within the angular range enclosed by the fasteners 64, 66, 68, 70.

Outer sprue bars 50 are disposed on the outer surface 52 of the elastic body 10. The outer sprue bars 50 are configured on the outer surface 52 in the area of the fasteners 64, 66, 68, 70. Each of the outer sprue bars 50 may be disposed in the area of an apex of the outer surface 52. In other words, the outer sprue bars 50 may each be disposed in an area of the outer surface 52 where the curvature of the outer surface 52 changes. The sprue bars 50 are arranged radially outwardly of the fasteners 64, 66, 68, 70. The outer sprue bars 50 may be on imaginary radial lines extending through the central axis M of the elastic body 10 and the central axes of the fastening apertures 14, 16, 18, 20, with FIG. 6 only showing the central axes MB₁₆ and MB₂₀ of the fastening apertures 16 and 20.

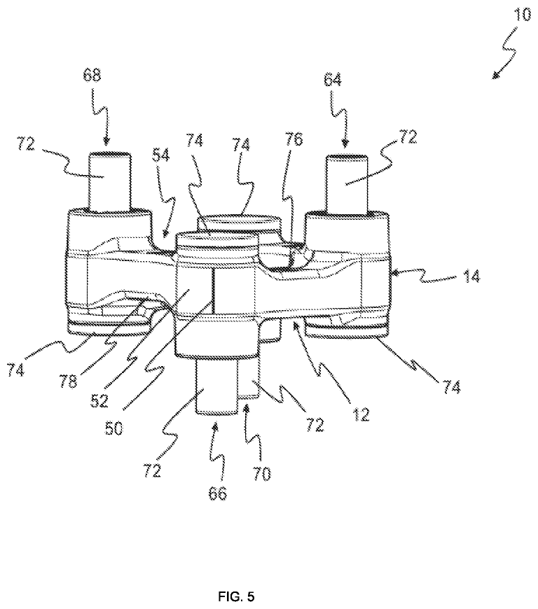

FIG. 7 is an enlarged view of section VII in FIG. 6. FIG. 6 shows the portion of the elastic sheath 14 in which the fastening aperture 16 for the fastener 64 is configured (see FIG. 6). The fastening aperture 16 is configured in the elastic sheath 14 and receives the fastener 64, as shown in FIGS. 3 to 6. The annular surface 34 extends around the fastening aperture 16. The positioning points 56 are configured on the annular surface 34. The positioning points 56 extend into the elastic sheath 14 in the axial direction. The positioning points 56 are configured around the central axis MB₁₆ of the fastening aperture 16 and the fastener 64 (not illustrated), respectively, at predetermined angular distances with an offset relative to each other. The positioning points 56 may be offset relative to each other by 120°, for example.

The positioning points 56 are elongated and have rounded radially outer ends. The positioning points 56 are each confined by a layer 80 of the elastic sheath 14 at the radially outer end. The radially inner ends of the positioning points 56 are open. This also applies to the further positioning points 24, 26, 28, 30 and 58, 60, 62, which are also open at their radially inner ends and confined by a radially outer layer of the elastic sheath 14 at their radially outer ends (see FIGS. 1 to 6).

FIG. 7 shows the inner sprue bar 48 and the outer sprue bar 50. The sprue bars 48, 50 are arranged in the area of the fastening aperture 16 and in the area of the fastener 64, respectively (see FIG. 6). The sprue bars 48, 50 are on an imaginary radial line extending through the central axis MB₁₆ of the fastening aperture 16 illustrated in FIG. 7. The sprue bars 48, 50 extend in the axial direction.

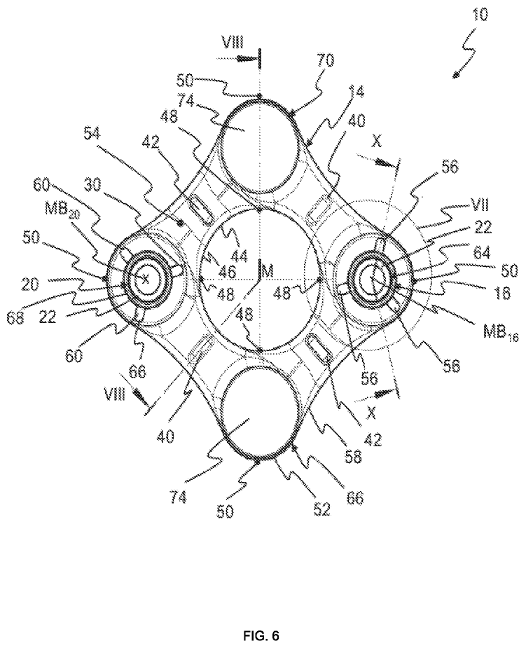

FIG. 8 is a sectional view along section line VIII-VIII in FIG. 6. In the sectional view according to FIG. 8, the fasteners 64, 66, 70 can be seen. The fasteners 64, 66, 70 are formed by a tubular or bolt-shaped portion 72 and a disk-shaped end member 74. FIG. 8 shows three thread packages 82, 84, 86. As exemplified by the fastener 70, the fasteners 64, 66, 68, 70 are wrapped by two thread packages 82 and 84. No additional support devices are provided to support the thread packages 82, 84 on the fasteners 64, 66, 68, 70. The thread packages 82, 84 and 86 are at least partially embedded in the elastic sheath 14. The fasteners 64, 66, 68, 70 extend through the elastic sheath 14.

Each of the thread packages 82, 84, 86 surrounds two fasteners 64, 66, 68, 70. Each of the fasteners 64, 66, 68, 70 is wrapped by two thread packages 82, 84, 86, as can be seen from the fastener 70 in the sectional view according to FIG. 8. The thread package 86 is embedded in the elastic sheath 14 in the circumferential direction between the fasteners 66 and 68 (see FIG. 3). In this area, the positioning point 42 is configured on the axial side 12 of the elastic body 10. The positioning point 40 is configured on the opposite axial side 54 of the elastic body 10. Thus, positioning points 40 and 42 are provided on the two axial sides 12 and 54 of the elastic body 10. The positioning points 40 and 42 are used to position the thread package 86 in the axial direction in an area of the elastic body 10 between two adjacent fasteners 64, 66, 68, 70 when manufacturing the elastic body 10. The thread package 86 is arranged in the axial direction between the two positioning points 40 and 42. The two positioning points 40 and 42 extend into the elastic sheath 14 in the direction of the axial side surfaces of the thread package 86. The positioning points 40 and 42 can be used to adjust the axial position of the thread package 86 in the elastic sheath 14 and thus also the course of the thread package 86 in the elastic sheath 14.

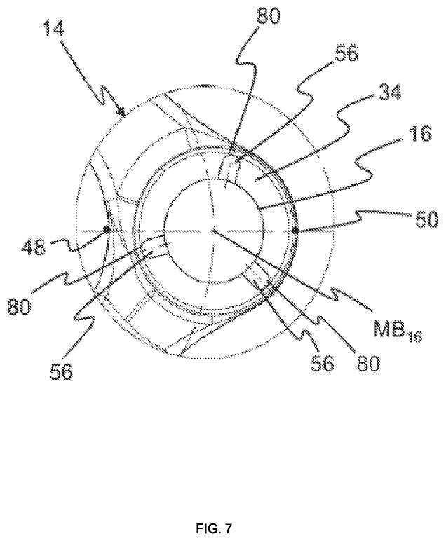

FIG. 9 is an enlarged view of section IX in FIG. 8. The thread package 86 is embedded in the elastic sheath 14, which means that the thread package 86 is surrounded by the elastic sheath 14 in the area between the fasteners 66 and 68.

The positioning points 40 and 42 extend into the elastic sheath 14 from both axial sides 12 and 54 of the elastic body 10. The positioning points 40 and 42 extend in the direction of the axial side surfaces of the thread package 86. The positioning points 40 and 42 have different axial depths. The positioning point 42 has a greater axial depth than the positioning point 40. The elastic sheath 14 has a greater axial thickness in the area between the fasteners, meaning the fasteners 66 and 68 (see FIG. 6), on the axial side 12 than on the axial side 54. The different axial depths of the positioning points 40 and 42 make it clear that the positioning points 40 and 42 can specify and precisely adjust the axial position of the thread package 86 and its course relative to the elastic sheath 14.

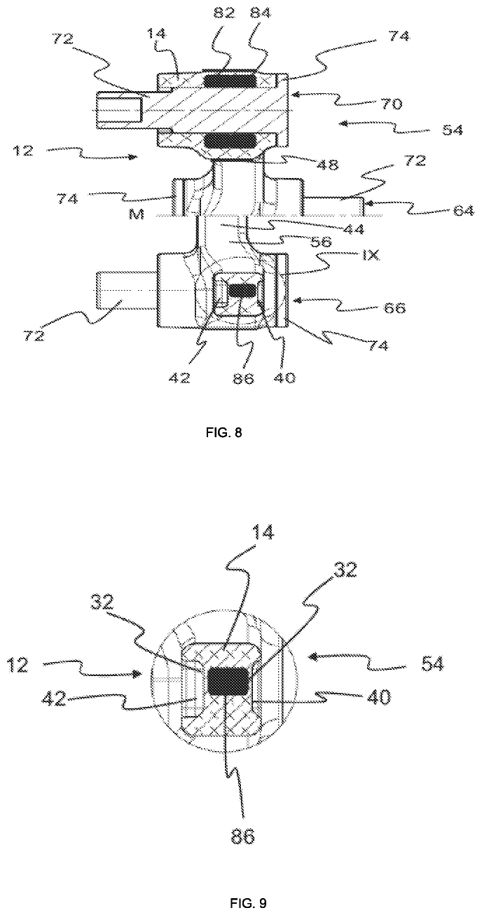

FIG. 10 is a sectional view along section line X-X in FIG. 6, i. e. FIG. 10 is a sectional view through the fastener 64 and its surroundings. The fastener 64 is wrapped by the thread packages 84 and 88. The thread packages 84 and 88 are embedded in the elastic sheath 14 in the wrap-around area of the fastener 64. The positioning points 24 and 56 are provided to position the thread packages 84 and 88 in this area. At their radially outer ends, the positioning points 24 and 56 are confined by the layer 80 of the elastic sheath 14. The positioning points 24 and 56 are open towards the fastener 64. The positioning point 56 has a greater axial extent or axial depth than the positioning point 24. The positioning point 24 has a smaller axial depth. The positioning point 24 is covered by the disk-shaped portion 74 of the fastener 64. The axial thickness of the elastic layer 14 in the wrap-around area of the fastener 64 is greater on the axial side 54 than on the axial side 12. No additional support devices supporting the thread packages 84 and 88 are arranged on the fastener 64.

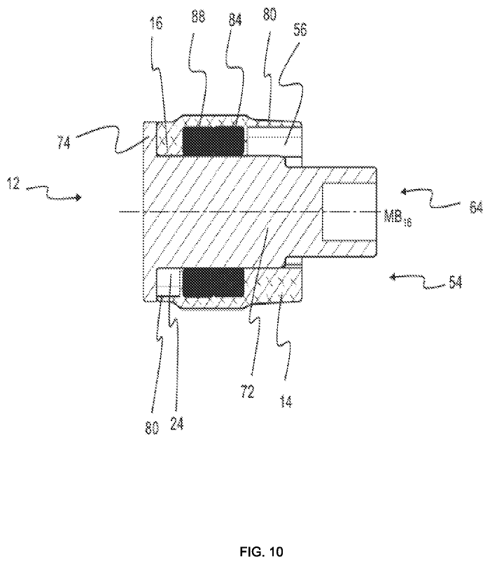

FIG. 11 is a perspective view of an elastic body 10 according to a second embodiment. The second embodiment of the elastic body 10, too, is an elastic joint body which may also be referred to as a joint disk. The main difference to the first embodiment described with reference to FIGS. 1 to 10 is the configuration of the positioning points 24, 26, 28, 30 and 56, 58, 60, 62, which are arranged on the fasteners 16, 18, 20, 22. Unlike in the first embodiment, the positioning points 24, 26, 28, 30 and 56, 58, 60, 62, which are arranged on the fasteners or around the fasteners 16, 18, 20, 22, are slit-shaped, i.e. the positioning points are open at their radially inner ends and at their radially outer ends. Otherwise, the explanations regarding the first embodiment also apply to the second embodiment described below with reference to FIGS. 11 to 17.

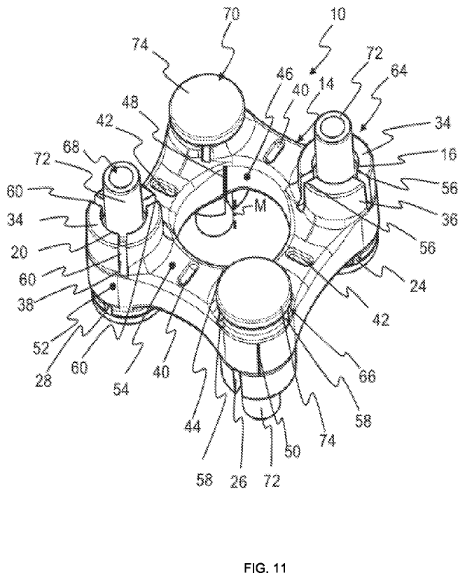

FIG. 12 is a front view of the elastic body 10. FIG. 12 makes it clear that the positioning points 24, 26, 28, 30 extend from the axial side 12 into the elastic sheath 14. The positioning points 56, 58, 60, 62 extend from the axial side 54 into the elastic sheath 14. FIG. 12 only illustrates the positioning points 24, 26, 28 and 26, 58, 60.

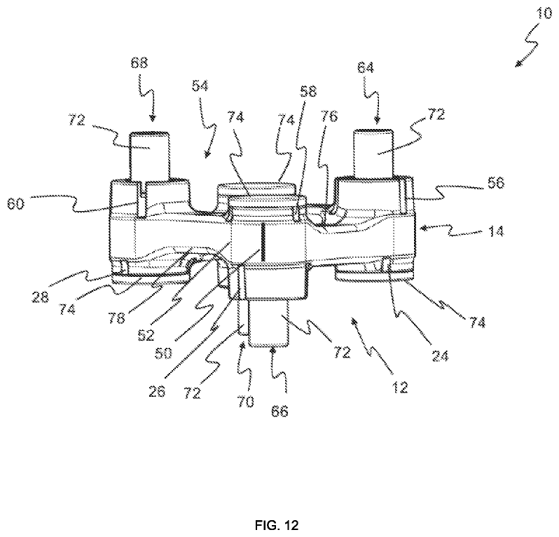

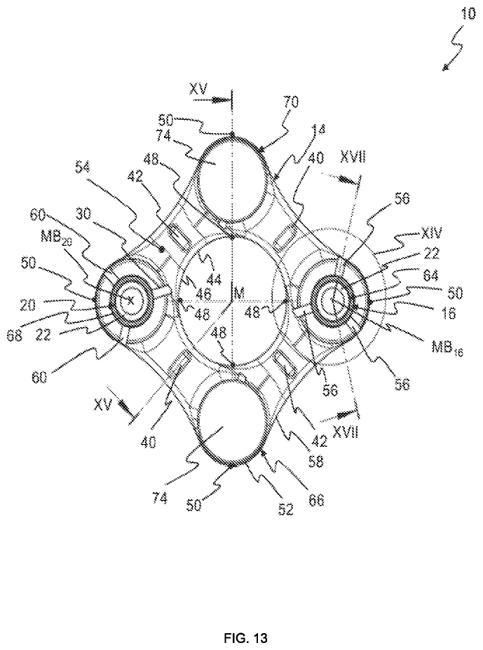

FIG. 13 is a top view of the elastic body 10. FIG. 14 is an enlarged view of section XIV in FIG. 13. FIGS. 13 and 14 show that the positioning points 24, 26, 28, 30 and 56, 58, 60, 62 are slit-shaped and extend in the elastic sheath 14. The positioning points 24, 26, 28, 30 and 56, 58, 60, 62 are open at their two radial ends. The positioning points 24, 26, 28, 30 and 56, 58, 60, 62 divide the annular surfaces 34 surrounding the fasteners 16, 18, 20, 22 into angular segments of equal size.

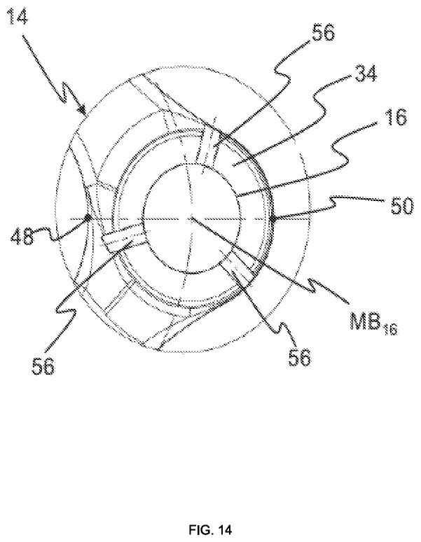

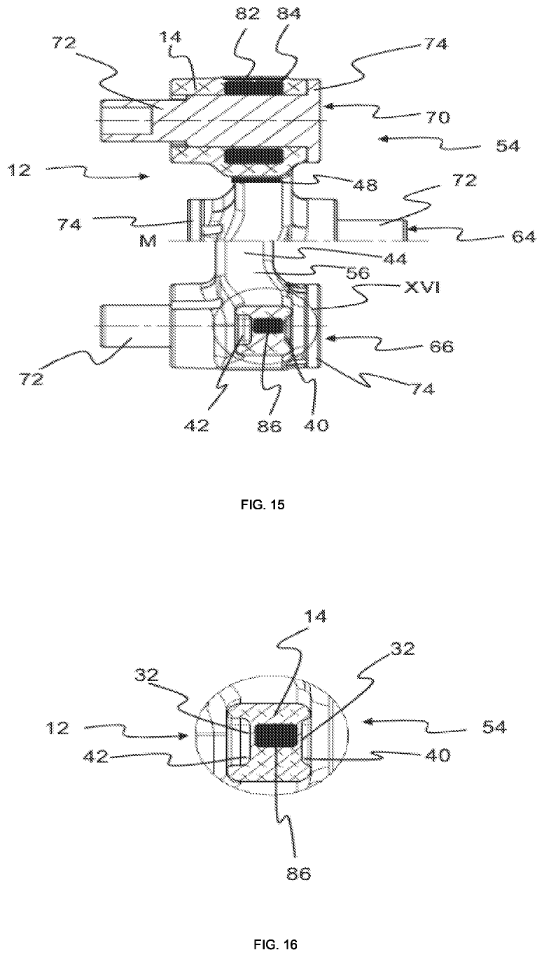

FIG. 15 is a sectional view along section line XV-XV in FIG. 13. FIG. 16 is an enlarged view of section XVI in FIG. 15. FIGS. 15 and 16 largely correspond to FIGS. 8 and 9. The foregoing explanations with respect to FIGS. 8 and 9 thus apply analogously to FIGS. 15 and 16.

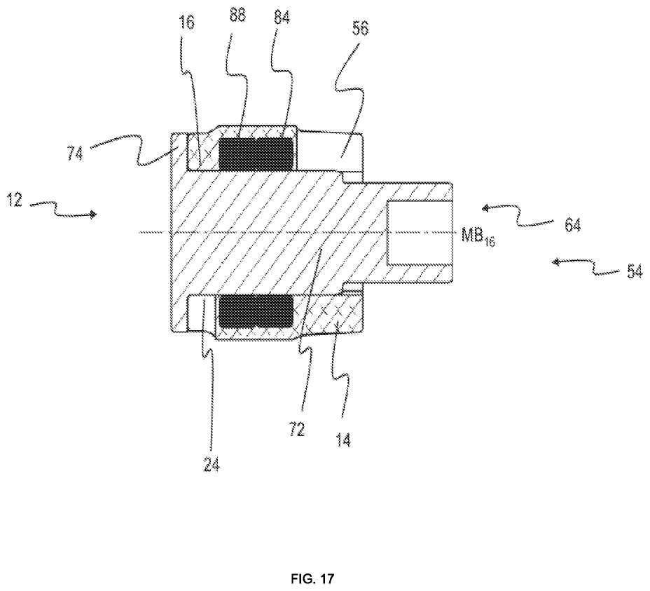

FIG. 17 is a sectional view along section line XVII-XVII in FIG. 13. The positioning points 24 and 56 extend into the elastic sheath 14 from the opposite axial sides 12 and 54. The positioning point 56 on the axial side 54 has a greater axial depth than the positioning point 24 on the axial side 12 also in the second embodiment. The positioning points 24 and 56 are continuous in the radial direction, meaning that the positioning points 24 and 56 are slit-shaped and extend through the elastic sheath 14 in the radial direction.

What is claimed is:

1. An elastic body comprising:
at least two fastening apertures;
at least one thread package surrounding the at least two fastening apertures;
at least one elastic sheath at least partially sheathing the at least one thread package; and
wherein the elastic body has at least one positioning point at at least one fastening aperture on the elastic sheath, via which the position of the at least one thread package in the elastic sheath is adjustable at least in the axial direction.

2. The elastic body of claim 1, wherein a plurality of positioning points are provided in the elastic sheath in the wrap-around area in which the at least one thread package surrounds one of the fastening apertures.

3. The elastic body of claim 1, wherein the at least one positioning point extends in the radial direction.

4. The elastic body of claim 1, wherein the positioning points, with respect to the central axis of a fastening aperture, are configured at the fastening aperture with an offset relative to each other by a predetermined angular distance.

5. The elastic body of claim 1, wherein at least one positioning point is provided between two fastening apertures.

6. The elastic body of claim 1, wherein the elastic body has two axial sides, wherein positioning points are configured in the elastic sheath on each axial side.

7. The elastic body of claim 1, wherein the positioning points have different axial depths.

8. The elastic body of claim 1, wherein the at least one thread package is arranged in the axial direction between two positioning points.

9. The elastic body of claim 1, wherein the at least one positioning point extends in the direction of one of the axial side surfaces of the at least one thread package.

10. The elastic body of claim 1, wherein a layer of the elastic sheath remains in place between the bottom of the at least one positioning point and the at least one thread package.

11. The elastic body of claim 1, wherein the thickness of the elastic sheath changes circumferentially on an axial side of the elastic body.

12. The elastic body of claim 11, wherein the thickness of the elastic sheath is the greatest in the area of the fastening apertures.

13. The elastic body of claim 1, wherein the elastic sheath has at least one recess on at least one axial side of the elastic body.

14. The elastic body of claim 1, wherein the elastic body comprises at least one sprue element, wherein at least the at least one thread package, starting from the at least one sprue element, is at least partially sheathed with an elastic sheath.

15. The elastic body of claim 14, wherein the at least one sprue element is configured on at least one surface of the elastic body extending in the axial direction.

16. The elastic body of claim 14, wherein the at least one sprue element is at least one sprue bar.

17. The elastic body of claim 14, wherein the elastic body comprises at least one central aperture, wherein the central aperture has an inner peripheral surface on which the at least one sprue element is configured.

18. The elastic body of claim 14, wherein the at least one sprue element is configured on the elastic sheath radially inwardly or radially outwardly of the at least one fastening aperture with respect to the central axis of the elastic body.

19. The elastic body of claim 1, wherein the elastic body is formed by arranging at least one thread package in an injection mold, wherein the at least one thread package is held in a predetermined position by a retainer at at least one positioning point, wherein the retainer holds the at least one thread package in the predetermined axial position throughout the injection process and vulcanization process of the elastic body.

20. The elastic body of claim 1, wherein the at least one elastic body is configured for connection to at least one two-armed flange.

21. The elastic body of claim 1, wherein the at least one elastic body is configured for use in a vehicle's steering column.
